(19) United States
(12) Patent Application Publication
(10) Pub. No.: US 2014/0298884 A1
(43) Pub. Date: Oct. 9, 2014

(54) SELF-CALIBRATING PRESSURE SENSOR SYSTEM WITH PRESSURE SENSOR AND REFERENCE SENSOR THAT SHARE COMMON SEALED CHAMBER

(71) Applicant: MKS Instruments, Inc., Andover, MA (US)

(72) Inventors: Leonid Mindlin, Natick, MA (US); Stephen F. Bart, Newton, MA (US); Lei Gu, Lexington, MA (US)

(73) Assignee: MKS Instruments, Inc., Andover, MA (US)

(21) Appl. No.: 14/101,177

(22) Filed: Dec. 9, 2013

Related U.S. Application Data
(60) Provisional application No. 61/808,443, filed on Apr. 4, 2013.

(51) Int. Cl. G01L 27/00

(52) U.S. Cl. CPC G01L 27/005
USPC 73/1.63; 29/428

(57) ABSTRACT

A self-calibrating pressure sensor system may measure the pressure of a gas or liquid. The system may include a pressure sensor, a reference sensor, and a drift compensation system. The pressure sensor may include a pressure-sensing flexible diaphragm with one side exposed to the gas or liquid and another side forming a wall of a sealed chamber. The reference sensor may include a reference flexible diaphragm that has two sides that are both within or exposed to the same sealed chamber. The drift compensation system may produce information that is indicative of the pressure of the gas or liquid based on the signal from the pressure sensor, and compensate for drift in this signal based on changes in the signal from the reference sensor. The pressure-sensing flexible diaphragm and the reference flexible diaphragm may be made at substantially the same time by depositing or growing a single layer of material in a single continuous step.

### CROSS-REFERENCE TO RELATED APPLICATION

This application is based upon and claims priority to U.S. provisional patent application 61/808,443, entitled “Auto-Zeroing Pressure Sensor,” filed Apr. 4, 2013, attorney docket number 086400-0171 (MKS-231 PR). The entire content of this application is incorporated herein by reference.

### BACKGROUND

1. Technical Field

This disclosure relates to pressure sensors for sensing the pressure of a gas or liquid and to micro-electro-mechanical system (MEMS) technology.

2. Description of Related Art

A pressure sensor can be used to sense the pressure of a gas or liquid.

Before use, the pressure sensor may be calibrated against a known pressure. Notwithstanding, the accuracy of the pressure sensor may deteriorate due to changes in characteristics of the pressure sensor that may be caused by age and environmental conditions. The pressure sensor may therefore need to be re-calibrated repeatedly, adding costs and sometimes requiring the pressure sensor to temporarily be removed from performing its pressure-sensing function.

A reference sensor may be provided to aid with the calibration. The reference sensor may be exposed to the same environment as the pressure sensor, except that the reference sensor may be insensitive to changes in the pressure of the gas or liquid. Changes in the reference sensor may then be used by a drift compensation system to compensate for drift in the pressure sensor. The accuracy of the drift compensation, however, can be diminished by inequalities between the pressure sensor and the reference sensor. Adding a reference sensor can also increase manufacturing costs and the size of the pressure sensor system.

### SUMMARY

A self-calibrating pressure sensor system may measure the pressure of a gas or liquid. The system may include a pressure sensor, a reference sensor, and a drift compensation system. The pressure sensor may include a pressure-sensing flexible diaphragm with one side exposed to the gas or liquid and another side forming a wall of a sealed chamber. The reference sensor may include a reference flexible diaphragm that has two sides that are both within or exposed to the same sealed chamber. The drift compensation system may produce information that is indicative of the pressure of the gas or liquid based on the signal from the pressure sensor, and compensate for drift in the signal from the pressure sensor based on changes in the signal from the reference sensor.

The pressure sensor may include a pressure electrode that is spaced from the pressure-sensing flexible diaphragm and that forms a capacitor with the pressure-sensing flexible diaphragm that has a capacitance that varies as a function of the pressure of the liquid or gas.

The pressure sensor may have characteristic planar dimensions of between 1 and 1000 microns, characteristic conformal layer thickness of between 0.1 and 20 microns, and one or more layers of silicon, silicon dioxide, silicon nitride, or metal.

The space between the pressure electrode and the pressure-sensing diaphragm may not be exposed to the gas or liquid.

The pressure electrode may have two sides, both of which are isolated from the gas or liquid.

The pressure electrode may be within the sealed chamber.

The reference sensor may include a reference electrode that is spaced from the reference flexible diaphragm and that forms a capacitor with the reference flexible diaphragm that has a capacitance that does not vary in response to changes in the pressure of the liquid or gas.

The reference sensor may have characteristic planar dimensions of between 1 and 1000 microns, characteristic conformal layer thickness of between 0.1 and 20 microns, and one or more layers of silicon, silicon dioxide, silicon nitride, or metal.

The space between the reference electrode and the reference flexible diaphragm may not be exposed to the gas or liquid.

The reference electrode may have two sides, both of which are isolated from the gas or liquid.

The reference electrode may be within the sealed chamber.

Both flexible diaphragms may be substantially flat and made of a single crystal material.

Both flexible diaphragms may be substantially identical in size, shape, thickness, and material composition.

The pressure sensor and the reference sensor may be substantially identical in size, shape, thickness, and material composition.

The self-calibrating pressure sensor system may include an environment sensor positioned so as to sense a change in the environment in which the pressure sensor is placed, but not a change in the pressure of the gas or liquid.

A method of making a self-calibrating pressure sensor system for measuring the pressure of a gas or liquid may include making a pressure sensor that includes a pressure-sensing flexible diaphragm positioned such that one side is exposed to the gas or liquid, and making a reference sensor that includes a reference flexible diaphragm positioned such that no side is exposed to the gas or liquid. The pressure-sensing flexible diaphragm and the reference flexible diaphragm may be made at substantially the same time by depositing or growing a single layer of material in a single continuous step.

The single layer of material may be a single crystal material.

The electrodes of the pressure sensor and the reference sensor may be made at substantially the same time by depositing or growing a single layer of material in a single continuous step.

The space between the electrode in the pressure sensor and the pressure-sensing flexible diaphragm and the space between the electrode in the reference sensor and the reference flexible diaphragm may be made at substantially the same time by depositing or growing a single layer of material in a single continuous step.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a pressure sensor and a matching reference sensor that may both be fabricated at the same time using micro-electro-mechanical system (MEMS) deposition, patterning, and etching technology.

FIGS. 2A-2D illustrate various perspective views of an example of a pressure sensor and a matching reference sensor that may both be fabricated at the same time using micro-electro-mechanical system (MEMS) deposition, pattering, and etching technology. FIG. 2A illustrates a top view; FIG. 2B illustrates the same top view with the top cap removed; FIG. 2C illustrates a bottom view; FIG. 2D illustrates the same bottom view with the bottom layer removed; and FIG. 2E illustrates a cross-sectional view showing a portion of a shared sealed chamber.

FIG. 3 illustrates an example of a self-calibrating pressure sensor system.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

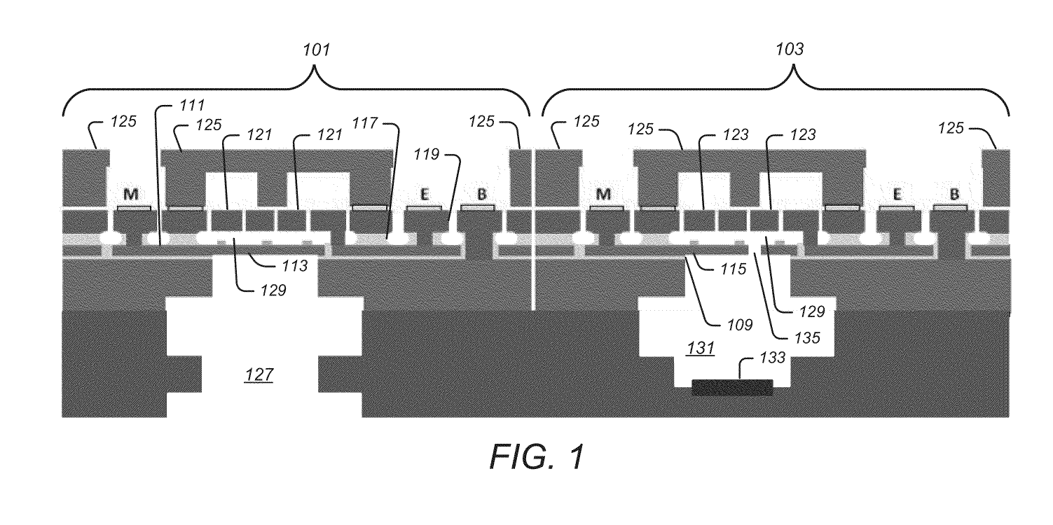

FIG. 1 illustrates an example of a pressure sensor 101 and a matching reference sensor 103 that may both be fabricated at the same time using micro-electro-mechanical system (MEMS) deposition, patterning, and etching technology. More specifically, each of the corresponding components of the pressure sensor 101 and the matching reference sensor 103 may be made at the same time, layer by layer. Each layer may be deposited and/or grown and may be made of any material, such as silicon, silicon dioxide, silicon nitrate, or metal. After depositing, each layer may be patterned so as to demarcate portions of the layer that are to be removed, and those portions may then be removed using an etching process. The result may be a structure, such as is shown in FIG. 1, that, for both the pressure sensor 101 and the reference sensor 103, includes planar dimensions of between 1 and 1000 microns and characteristic conformal layer thickness of between 0.1 and 20 microns.

A substrate layer 105 may be made of silicon, glass, or sapphire. Other layers 107 and 109 may follow, followed by a layer 111. The layer 111 may function as a substantially flat pressure-sensing flexible diaphragm 113 that may form part of the pressure sensor 101 and, at the same time during the same continuous deposition step, an identical substantially flat reference flexible diaphragm 115 that may form part of the reference sensor 103. The layer 111 may be made of any material, such as a single crystal material.

Following an insulation layer 117, an electrically conducting layer, such as a conductively doped poly-Silicon layer 119 may be deposited, patterned, and etched so as to form electrodes 121 that may be part of the pressure sensor 101 and, at the same time during the same continuous deposition step, electrodes 123 that may be part of the reference sensor 103. The electrodes 121 and 123 may be spaced from their respective diaphragms 113 and 115 and, in conjunction with their respective diaphragms, may form a capacitor whose capacitance changes as a function of changes in their respective diaphragms. In this configuration, the layer that forms the diaphragms may be made of metal or a doped Si conductor. The electrodes may be within or forms walls of a shared sealed chamber 129.

In other embodiments, there may be no electrodes, but rather one or more strain gauges mounted on each of the diaphragms. In these other embodiments, changes in the diaphragms may be detected by changes in the signals from the strain gauges.

One or more additional layers may be deposited, patterned, and etched so as to form a cap 125 that may protect the electrodes 121 and 123.

The various etched layers may cooperate to form various chambers within the pressure sensor 101 and/or the reference sensor 103.

For example, the various etched layers may cooperate to form an inlet chamber 127 through which a gas or liquid whose pressure is to be measured may flow. One side of the diaphragm 113 of the pressure sensor 101 may form a wall of the inlet chamber 127 and thus be exposed to the gas or liquid whose pressure is to be measured. The other side of the diaphragm 113 may form a wall of the sealed chamber 129.

Similarly, the various layers may cooperate to form a reference chamber 131 in the reference sensor 103, one side of which may include one side of the reference flexible diaphragm 115. The reference chamber 131 may include a getter 133 that may include material of a type that absorbs impurities in the reference chamber 131, such as oxygen, nitrogen, hydrogen, carbon monoxide. For example, the getter 133 may be made of or include a zirconium alloy, tantalum alloy, columbium alloy, thorium alloy, titanium alloy, magnesium alloy and/or a barium alloy. The other side of the reference flexible diaphragm 115 may form another wall of the shared sealed chamber 129. The reference flexible diaphragm 115 may include an opening 135 through which gas may travel, thereby causing both sides of the reference flexible diaphragm 115 and one side of the pressure-sensing flexible diaphragm 113 to all be exposed to and thus to all share the shared sealed chamber 129. There may be an additional or different gas passageway between the reference chamber 131 and the shared sealed chamber 129.

Changes to the pressure-sensing flexible diaphragm 113 may be caused both by corresponding changes in the pressure of the gas or liquid to be measured and by aging of the pressure-sensing flexible diaphragm 113 and/or changes in the surrounding environment, other than a change in the pressure of the gas or liquid to be measured, such as changes in temperature, humidity, and/or barometric pressure. The changes to the reference flexible diaphragm 115, on the other hand, may only be caused by aging of the reference flexible diaphragm 115 and/or changes in the surrounding environment. Thus, the changes to the reference flexible diaphragm 115 may be the same as the changes to the pressure-sensing flexible diaphragm 113 that are caused by aging/environmental changes. Thus, measurements of the changes to the flexible diaphragm 115 may serve as an indication of the changes to the pressure-sensing flexible diaphragm 113 that are also being caused by the same aging/environmental changes.

The corresponding components of the pressure sensor 101 and the reference sensor 103, such as the diaphragms 113 and 115, respectively, may be substantially identical in size, shape, thickness, and/or material composition. This may help ensure that the changes to the reference flexible diaphragm 115 due to aging/environmental changes are substantially the same as the changes to the pressure-sensing flexible diaphragm 113 due to aging/environmental changes.

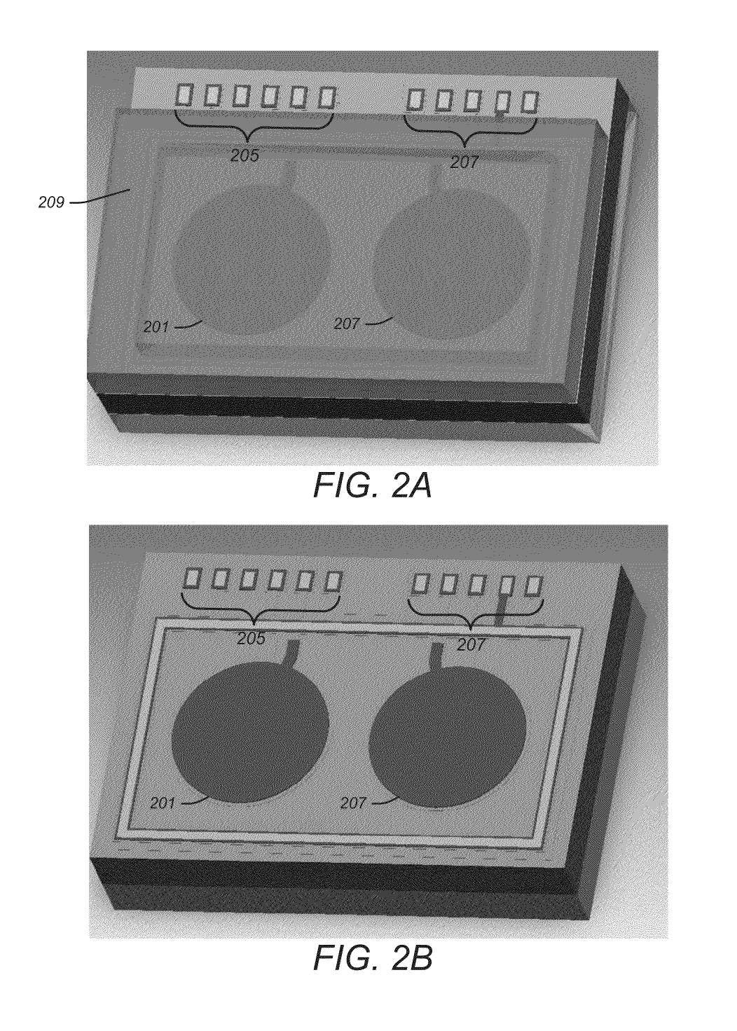

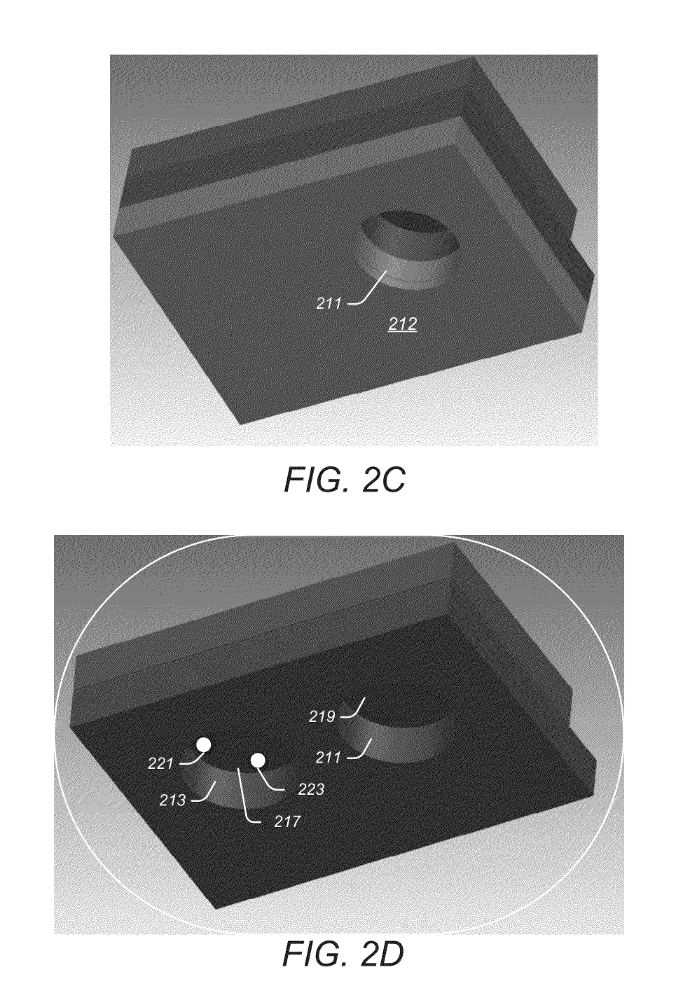

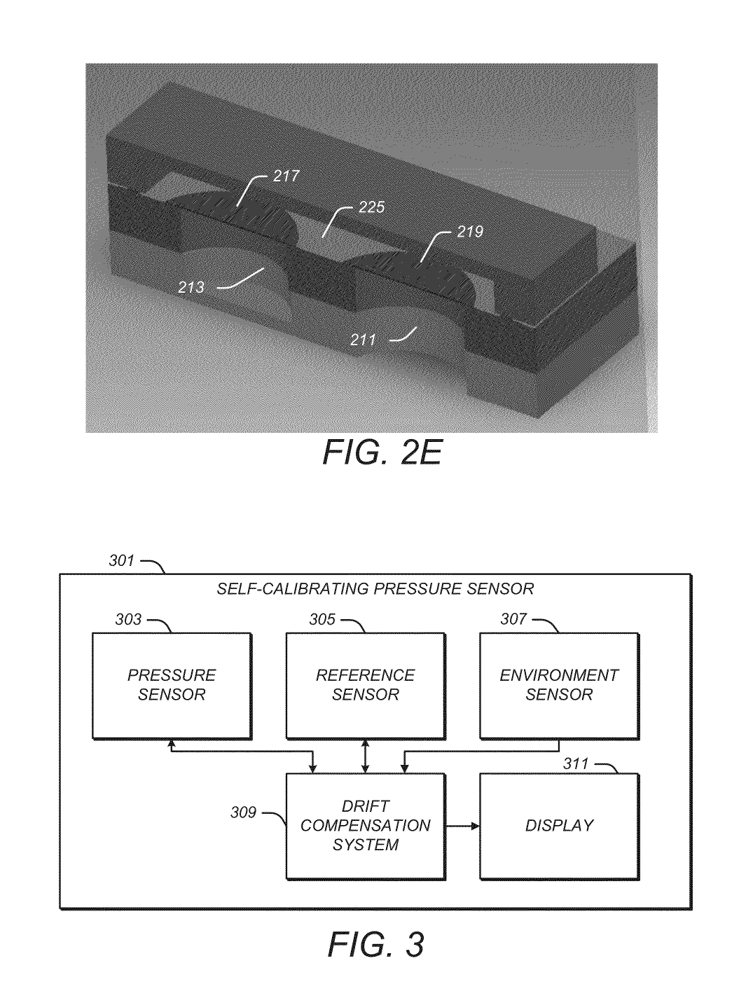

FIGS. 2A-2D illustrate various perspective views of an example of a pressure sensor 203 and a matching reference sensor 201 that may be both fabricated at the same time using micro-electro-mechanical system (MEMS) deposition, pattering, and etching technology.

FIG. 2A illustrates a top view of these sensors. Electrical connections with the reference sensor 201 may be made through electrical connections 205. Electrical connections with the pressure sensor 203 may be made through the electrical connections 207. The pressure sensor 203 and the matching reference sensor 201 may have the same or different configurations than and may be made by the same or different process as the pressure sensor 101 and reference sensor 103 illustrated in FIG. 1 and discussed above. The sensors may be capped by a top cap 209.

FIG. 2B illustrates the same top view of these sensors as FIG. 2A, but with the top cap 209 removed.

FIG. 2C illustrates a bottom view of the sensors. An inlet chamber 211 to the pressure sensor 203 may be provided that may be the same as or different from the inlet chamber 127 illustrated in FIG. 1. The inlet chamber 211 may pass thorough a bottom layer 212 and may be exposed to the gas or liquid whose pressure is to be measured.

FIG. 2D illustrates the same bottom view as in FIG. 2C with the bottom layer 212 removed. As illustrated, there may be a reference chamber 213 that may be the same as or different from the reference chamber 131 in FIG. 1. There may also be a reference flexible diaphragm 217 that may be the same as or different from the flexible reference diagram 115 in FIG. 1, and a flexible pressure-sensing diaphragm 219 that may be the same as or different from the flexible pressure-sensing diaphragm 113 in FIG. 1. The flexible reference diaphragm 217 may also have one or more openings there through, such as openings 221 and 223, one of which may be the same as or different from the opening 135 in FIG. 1.

FIG. 2E illustrates a cross-sectional view of these sensors showing a portion of a shared sealed chamber 225. The shared sealed chamber 225 may be the same as or different from the shared sealed chamber 129 in FIG. 1.

FIG. 3 illustrates an example of a self-calibrating pressure sensor system 301. As illustrated, the self-calibrating pressure sensor system 301 may include a pressure sensor 303, a reference sensor 305, an environment sensor 307, a drift compensation system 309, and a display 311.

The pressure sensor 303 and the reference sensor 305 may be the same as or different from the pressure sensor 101 and the reference sensor 103 in FIG. 1 or the pressure sensor 203 and the reference sensor 201 in FIGS. 2A-2D, respectively.

The environment sensor 307 may be configured to sense changes in the environment in which the pressure sensor is placed, such as changes in the temperature, humidity, and/or pressure of the environment or changes in internal stress. However, the environment sensor 307 may be configured to be insensitive to changes in the pressure of the gas or liquid to be measured.

The drift compensation system 309 may be configured to receive signals from the pressure sensor 303, the reference sensor 305, and the environment sensor 307 that are indicative of the pressure of the gas or liquid to be measured, the aging of the pressure sensor, and the environment, respectively. The drift compensation system 309 may be configured to produce information that is indicative of the pressure of the gas or liquid to be measured based on the signal from the pressure sensor 303, but compensated for drift in the signal from the pressure sensor 303 caused by aging/environmental changes, as represented by the signal from the reference sensor 305, and/or compensated for changes in the environment, as represented by the signal from the environment sensor 307. The drift compensation system 309 may be configured to automatically adjust its output to zero when nothing other than atmospheric pressure is presented to the pressure sensor 303, based on the signals from the reference sensor 305 and/or environment sensor 307. The drift compensation system 309 may in addition or instead be configured to automatically adjust its output to be zero when a gas or liquid pressure is presented that is known to be at a zero point calibration pressure. The drift compensation system 309 may continue to apply the needed adjustment when the gas or liquid is no longer at the zero point calibration pressure.

The drift compensation system 309 may be configured to provide this compensation based on one or more algorithms. One algorithm, for example, may subtract the signal from the reference sensor 305 from the signal from the pressure sensor 303, thereby producing a signal representative of the pressure of the gas or liquid, automatically compensated for aging/environmental changes of the reference sensor 305 and hence aging/environmental changes of the pressure sensor 303. Another algorithm may further compensate this measurement for changes to the environment, as detected by the environment sensor 307 and/or the reference sensor 305, based on known relationships between changes in that environment and the measurements provided by the pressure sensor 303 and/or reference sensor 305. These known relationships may be determined empirically and/or through computation.

The drift compensation system 309 may operate in real time, thereby providing compensation for aging and changes in the environment, without requiring the self-calibrating pressure sensor 301 to be withdrawn from its pressure-sensing duties.

The output from the drift compensation system 309 may be indicative of the pressure of the gas or liquid to be measured, compensated for aging and environmental changes. This output may be delivered to the display 311 which may display this compensated measurement. The output may in addition or instead be delivered to another system that may perform operations based on the measured and compensated pressure and/or that may store the information for future use.

The drift compensation system 309 may be implemented by discrete or integrated electronic circuitry and/or by a general purpose computer. The hardware may include one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Software (e.g., one or more operating systems, device drivers, application programs, and/or communication programs) may also be included. When included, the software may include programming instructions and may include associated data and libraries. The programming instructions may be configured to implement one or more algorithms that implement one or more of the functions of the drift compensation system 309, as recited herein. The description of each function that is performed by the drift compensation system 309 also constitutes a description of the algorithm(s) that performs that function. The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

For example, the pressure sensor and reference sensor might not share the same sealed chamber, but may each have their own sealed chamber separate from the sealed chamber used by the other.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A self-calibrating pressure sensor system for measuring the pressure of a gas or liquid comprising:
a pressure sensor that includes a pressure-sensing flexible diaphragm positioned such that one side is exposed to the gas or liquid and another side forms a wall of a sealed chamber;
a reference sensor that includes a reference flexible diaphragm that has two sides that are both within or exposed to the sealed chamber; and
a drift compensation system that:
receives a signal from the pressure sensor and from the reference sensor;
produces information that is indicative of the pressure of the gas or liquid based on the signal from the pressure sensor; and
compensates for drift in the signal from the pressure sensor based on changes in the signal from the reference sensor.

2. The self-calibrating pressure sensor system of claim 1 wherein:
the pressure sensor includes a pressure electrode that is spaced from the pressure-sensing flexible diaphragm and that forms a capacitor with the pressure-sensing flexible diaphragm that has a capacitance that varies as a function of the pressure of the liquid or gas;
the pressure sensor has characteristic planar dimensions of between 1 and 1000 microns, characteristic conformal layer thickness of between 0.1 and 20 microns, and one or more layers of silicon, silicon dioxide, silicon nitride, or metal; and
the space between the pressure electrode and the pressure-sensing diaphragm is not exposed to the gas or liquid.

3. The self-calibrating pressure sensor system of claim 2 wherein the pressure electrode has two sides, both of which are isolated from the gas or liquid.

4. The self-calibrating pressure sensor system of claim 3 wherein the pressure electrode is within the sealed chamber.

5. The self-calibrating pressure sensor system of claim 2 wherein:
the reference sensor includes a reference electrode that is spaced from the reference flexible diaphragm and that forms a capacitor with the reference flexible diaphragm that has a capacitance that does not vary in response to changes in the pressure of the liquid or gas;
the reference sensor has characteristic planar dimensions of between 1 and 1000 microns, characteristic conformal layer thickness of between 0.1 and 20 microns, and one or more layers of silicon, silicon dioxide, silicon nitride, or metal; and
the space between the reference electrode and the reference flexible diaphragm is not exposed to the gas or liquid.

6. The self-calibrating pressure sensor system of claim 5 wherein the reference electrode has two sides, both of which are isolated from the gas or liquid.

7. The self-calibrating pressure sensor system of claim 6 wherein the reference electrode is within the sealed chamber.

8. The self-calibrating pressure sensor system of claim 1 wherein both flexible diaphragms are substantially flat and made of a single crystal material.

9. The self-calibrating pressure sensor system of claim 1 wherein both flexible diaphragms are substantially identical in size, shape, thickness, and material composition.

10. The self-calibrating pressure sensor of system of claim 9 wherein the pressure sensor and the reference sensor are substantially identical in size, shape, thickness, and material composition.

11. The self-calibrating pressure sensor system of claim 1 further comprising an environment sensor positioned so as to sense a change in the environment in which the pressure sensor is placed, but not a change in the pressure of the gas or liquid.

12. A method of making a self-calibrating pressure sensor system for measuring the pressure of a gas or liquid comprising:
making a pressure sensor that includes a pressure-sensing flexible diaphragm positioned such that one side is exposed to the gas or liquid; and
making a reference sensor that includes a reference flexible diaphragm positioned such that no side is exposed to the gas or liquid,
wherein the pressure-sensing flexible diaphragm and the reference flexible diaphragm are made at substantially the same time by depositing or growing a single layer of material in a single continuous step.

13. The method of claim 12 wherein the single layer of material is a single crystal material.

14. The method of claim 12 wherein the making of the pressure sensor and the reference sensor includes making planar dimensions of between 1 and 1000 microns, characteristic conformal layer thickness of between 0.1 and 20 microns, and one or more layers of silicon, silicon dioxide, silicon nitride, or metal.

15. The method of claim 12 wherein:
the other side of the pressure-sensing flexible diaphragm forms a wall of a sealed chamber; and
both sides of the reference flexible diaphragm are within the sealed chamber.

16. The method of claim 12 wherein both flexible diaphragms are substantially flat and made of a single crystal material.

17. The method of claim 12 wherein both flexible diaphragms are substantially identical in size, shape, and thickness.

18. The method of claim 12 the pressure sensor and the reference sensor are substantially identical in size, shape, thickness, and material composition.

19. The method of claim 12 further comprising making an environment sensor positioned so as to sense changes in the environment in which the pressure sensor is placed, but not changes in the pressure of the gas or liquid.

20. The method of claim 12 wherein:
the pressure sensor includes an electrode that is spaced from the pressure-sensing flexible diaphragm and that forms a capacitor with the pressure-sensing flexible diaphragm that has a capacitance that varies as a function of the pressure of the liquid or gas; and
the reference sensor includes an electrode that is spaced from the reference flexible diaphragm and that forms a capacitor with the reference flexible diaphragm that has a capacitance that does not vary as a function of the pressure of the liquid or gas.

21. The method of claim 20 wherein:
the electrodes of the pressure sensor and the reference sensor are made at substantially the same time by depositing or growing a single layer of material in a single continuous step; and
the space between the electrode in the pressure sensor and the pressure-sensing flexible diaphragm and the space between the electrode in the reference sensor and the reference flexible diaphragm are made at substantially the same time by depositing or growing a single layer of material in a single continuous step.
